(19) United States
(12) Patent Application Publication
(10) Pub. No.: US 2018/0372210 A1
(43) Pub. Date: Dec. 27, 2018

(54) Safety Bypass Valve

(71) Applicant: Bell Helicopter Textron Inc., Fort Worth, TX (US)

(72) Inventor: Scott David Poster, Arlington, TX (US)

(73) Assignee: Bell Helicopter Textron Inc., Fort Worth, TX (US)

(21) Appl. No.: 15/633,509

(22) Filed: Jun. 26, 2017

(51) Int. Cl. F16H 57/04; F16K 17/04; F16K 1/32; F16K 27/02; F16K 37/00; F16H 57/02; B64C 27/14

(52) U.S. Cl. CPC F16H 57/0435; F16K 17/04; F16K 1/32; F16K 27/0209; B64C 27/14; F16K 37/0041; F16H 57/02; F16H 57/0436; F16K 37/0058

(57) ABSTRACT

A pressure sensitive bypass valve for protecting the components of a fluid distribution system. The bypass valve includes a poppet designed to prevent fluid bypass in the event of spring failure, rather than from over-pressurization.

### BACKGROUND

Pressurized fluid systems that include equipment that is susceptible to damage caused by excessive pressure often include a pressure sensitive bypass valve. Presently available bypass valves utilize a spring biased poppet. The spring maintains the poppet in a closed position. If the fluid pressure reaches a predetermined level, the fluid pressure compresses the spring, opening the valve, and allowing the fluid to escape through an outlet in the bypass valve. The diversion of the fluid through the bypass valve saves the pressure sensitive equipment from being damaged. It also prevents the fluid from reaching its intended destination.

One example of such a pressurized fluid delivery system is included on an engine. An engine includes a series of channel through which oil is pumped under pressure from a sump to the moving parts and back to the sump, providing lubrication and aiding in the cooling of the engine. If there is a blockage in the channel, thereby causing the pressure to increase, the bypass valve is activated and the oil does not circulate through the engine. Instead, the oil pumped from the sump is diverted through the bypass valve and returns to the sump. Running an engine for an extended period of time without the circulation of oil can destroy the engine. As such, it is imperative to turn off the engine as soon as possible to fix the oil delivery system and prevent damage to the engine.

The design of existing bypass valves leave the valve in the open position if the spring fails. As such, one broken spring in one bypass valve can force a rotorcraft to divert its course and land for service. Given the mission critical nature of military and rescue rotorcraft, there exists a need for an improved bypass valve that does not mimic the behavior of over-pressurization in the event of spring failure.

### SUMMARY

An embodiment of the disclosure provides a housing that defines a chamber within. The chamber includes an inlet at a proximal end of the chamber and an outlet in a sidewall of the housing. Within the chamber are a poppet and a spring. The poppet includes a partition that is configured to extend across the width of the chamber. The poppet includes a sidewall extending from the partition to a first end. The first end is configured to face the inlet at the proximal end of the chamber. The sidewall of the poppet includes an opening therethough. The spring is located between the distal end of the chamber and the poppet and is configured to bias the poppet in to a first position, toward the inlet. In the first position, communication between the inlet and the outlet is blocked by the poppet.

Under normal operating pressure, the spring holds the poppet in the first position and the pressurized fluid flows past the inlet and circulates through the desired channel. If the fluid pressure rises above a predetermined acceptable limit, the pressure compresses the spring and slides the poppet to a second position. In the second position, the opening in the sidewall of the poppet aligns with the outlet in the sidewall of the housing, thereby permitting the pressurized fluid to pass through the bypass valve and relieve the excess pressure. In the case of spring failure, the poppet is permitted to slide further to a third position where a second end of the poppet, opposite the first end of the poppet, engages a shoulder near the distal end of the chamber. In the third position, the sidewall of the poppet covers the outlet in the sidewall of the housing, thereby permitting normal flow of the fluid through the fluid distribution system.

### BRIEF DESCRIPTION OF THE DRAWINGS

The accompanying drawings, which are incorporated in and constitute a part of the specification, illustrate preferred embodiments of the invention and, together with the description, serve to explain the objects, advantages, and principles of the invention.

FIG. 1A is a cross-sectional side view of a prior art bypass valve.

FIG. 1B is a cross-sectional side view of the prior art bypass valve of FIG. 1A.

FIG. 1C is a cross-sectional side view of the prior art bypass valve of FIGS. 1A and 1B.

FIG. 2A is a cross-sectional side view of a bypass valve according to an embodiment of the disclosure.

FIG. 2B is a cross-sectional side view of the bypass valve of FIG. 2A.

FIG. 2C is a cross-sectional side view of the bypass valve of FIGS. 2A and 2B.

FIG. 3 is an oblique view of a gearbox according to an embodiment of the disclosure.

FIG. 4 is a schematic showing a fluid movement system according to an embodiment of the disclosure.

### DETAILED DESCRIPTION

It should be understood that although an illustrative implementation of one or more embodiments are provided below, the disclosed systems and methods may be implemented using any number of techniques, whether currently known or in existence. The disclosure should in no way be limited to the illustrative implementations, drawings, and techniques illustrated below, including the exemplary designs and implementations described herein, but may be modified with the scope of the appended claims along with their full scope of equivalents.

In the disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc., and the components thereof described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

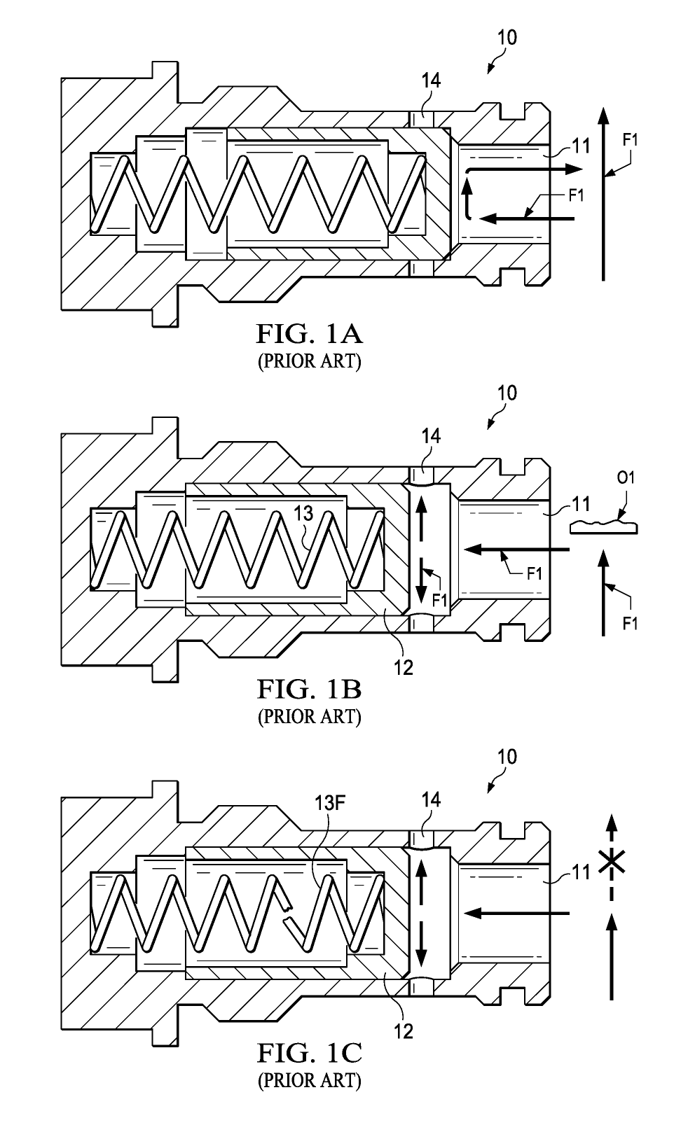

Referring to FIGS. 1A-1C, a prior art bypass valve 10 is illustrated. FIG. 1A shows the prior art valve 10 in a closed configuration. In the closed configuration, a fluid F1 flows past inlet 11. FIG. 1B shows the prior art valve 10 in an open configuration. In FIG. 1B, an obstruction O1 causes the pressure of the fluid F1 to increase. The increase in pressure applies a force to a poppet 12. The poppet 12 transfers the force to a spring 13, thereby compressing the spring 13 and allowing the poppet 12 to translate to the open configuration. In the open configuration, the fluid F1 flows through the inlet 11 and out an outlet 14. FIG. 1C shows the prior art valve in a spring failure configuration. FIG. 1C shows a failed spring 13F, which allows the fluid F1 to push the poppet 12 to the open position without a rise in the pressure of fluid F1. Since the bypass valve is open, a reduced amount or no fluid F1 is pumped to the upstream components.

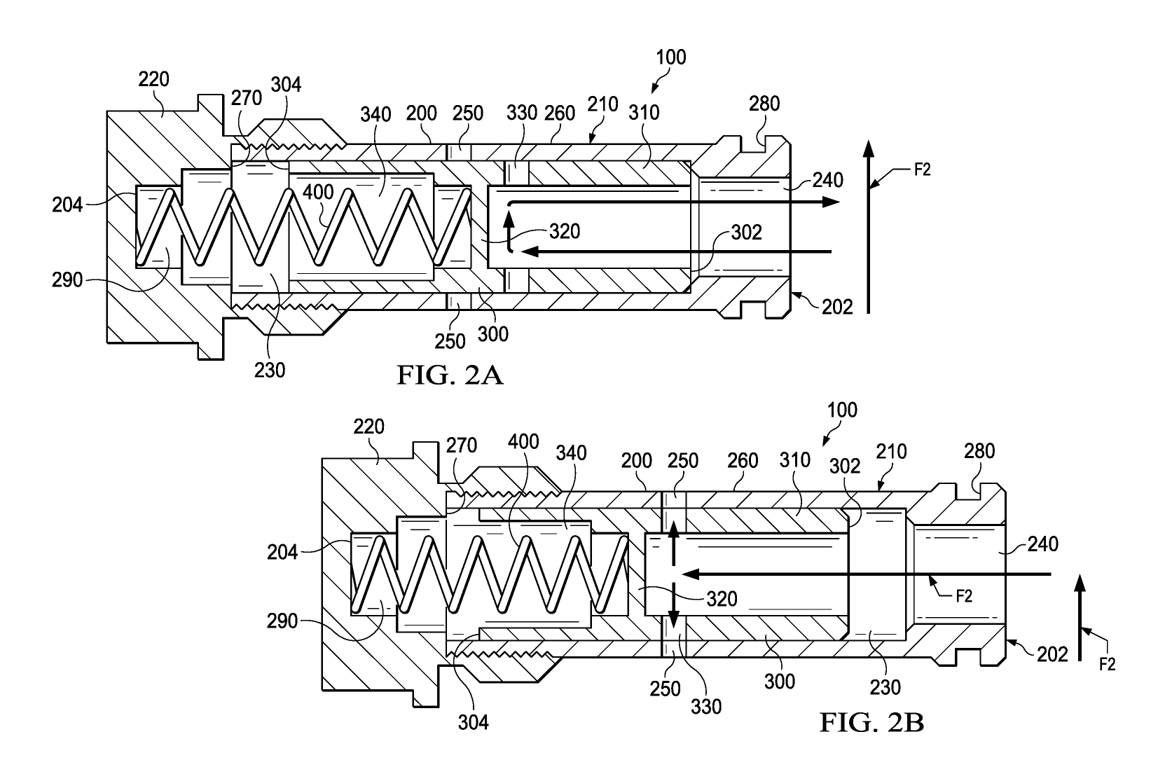

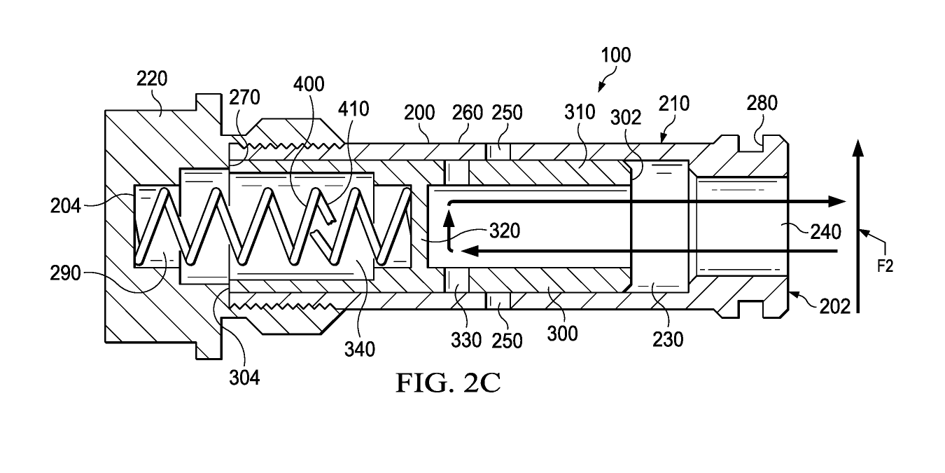

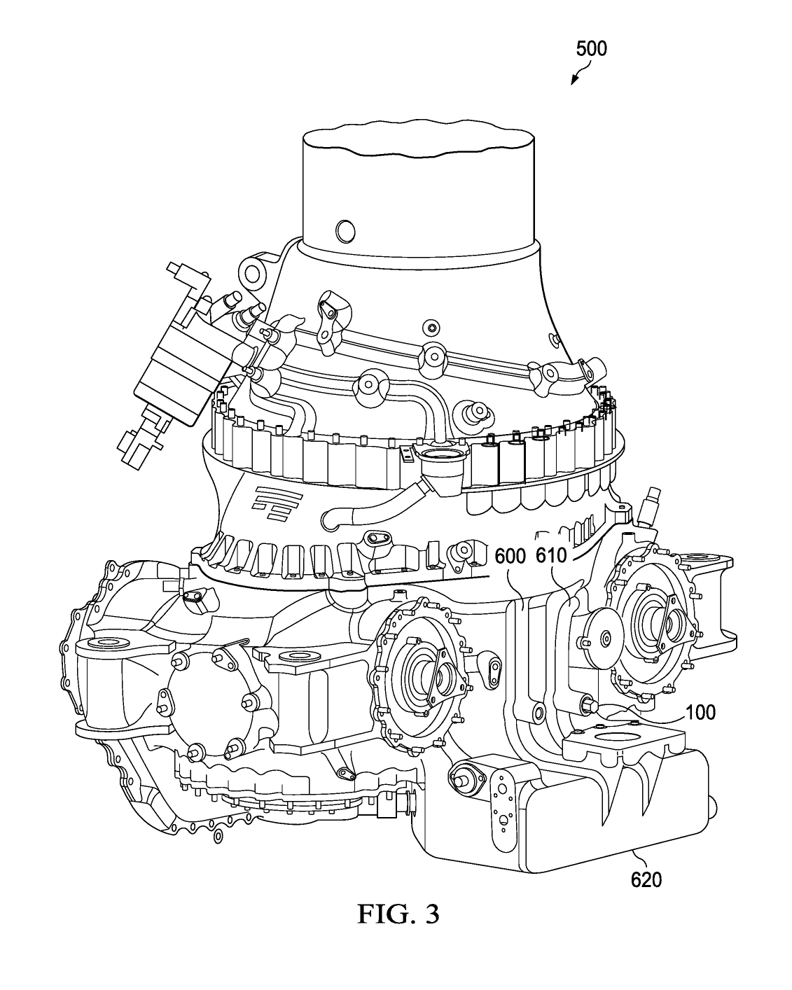

Referring to FIGS. 2A-2C, an improved bypass valve 100 is illustrated. The bypass valve 100 includes three basic components: a housing 200, a poppet 300, and a spring 400. The housing may include two pieces, a body 210 and a cap 220. The cap 220 and body 210 may include threads configured to form a connection therebetween. When assembled, the body 210 and the cap 220 define a chamber 230 therein. The chamber 230 is preferably generally cylindrical. However, the chamber 230 could be any suitable shape. The chamber 230 is in communication with an inlet 240 at a proximal end 202 of the housing 200. The chamber 230 is also in communication with one or more outlets 250 in a sidewall 260 of the housing 200. A stop 270 is located proximate a distal end 204 of the chamber 230. The stop 270 may comprise a shoulder or post or another other structure capable of engaging the poppet 300 and preventing further translation thereof. The structure may include one of more grooves 280 configured to receive an o-ring therein to facilitate a proper seal of the fluid movement system. The body 210 may include additional structure to facilitate attachment of the bypass valve 100 to the fluid channel. The attachment structure (not shown) may include external threads on the exterior of the body 210, internal threads on an interior of the inlet 240, additional grooves 280 configured to receive a snap-ring, or another means of facilitating attachment. The cap may also include structure for the engagement of a tool to assist in the attachment and/or removal of the bypass valve 100 to the fluid channel. The structure may include a hexagonal outer head (shown in FIG. 3), a hexagonal, star, Philips, or flathead impression configured to receive a rotational tool therein, or any other suitable engagement structure. The cap 220 may further include a recess 290 configured to receive and secure a spring 400 therein. The recess 290 may also be configured to receive shims between the cap 220 and the spring 400 to increase the force required to compress the spring 400 and thereby increase the allowable pressure in the fluid movement system.

The poppet 300 includes a generally cylindrical sidewall 310 which extends from a proximal end 302 to a distal end 304. The exterior surface of the sidewall 310 is sized and shaped to create a flush fit against the interior surface of the sidewall 260 of the body 210. The fit permitting the poppet 300 to translate within the chamber 230, but without permitting the fluid to pass between the exterior surface of the sidewall 310 and the interior surface of the sidewall 260. The poppet 300 also includes a partition 320 which extends from across the width of the poppet 300 between the proximal end 302 and the distal end 304. The poppet 300 also includes one or more openings 330 extending through the sidewall 310. The openings 330 are located between the partition 320 and the proximal end 302 of the poppet. The portion of the sidewall 310 between the opening 330 and the proximal end 302 should be longer than the width of the outlet 250 in the sidewall 260 of the body 210. The poppet 300 further includes a cavity 340 configured to receive the spring 400 therein.

The spring 400 is configured to bias the poppet 300 into a first position toward the inlet 240 of the housing 200, as shown in FIG. 2A. In the first position, some of the fluid F2 may enter the inlet 240 but it either remains in the chamber 230 or it flows back out the inlet 240. The pressure of the fluid F2 is felt by the partition 320 and that force is transferred to the spring 400. When the pressure of the fluid F2 increases to a predetermined level, the spring 400 is compressed, thereby allowing the poppet 300 to translate to a second position within the chamber 230, as shown in FIG. 2B. In the second position, the openings 330 are lined up with the outlets 250, thereby allowing the over pressurized fluid F2 to enter the chamber 230 through the inlet 240 and exit through the openings 330 and the outlets 250. If the pressure of the fluid F2 drops below the predetermined level, the spring 400 forces the poppet 300 back to the first position and the fluid movement system continues normal operation. It is important to note that the spring 400 should be configured to prevent the poppet 300 from additional translation due to excessive pressure. As such additional translation would close the valve and prevent pressure relief. This may be aided by making the outlets 250 and/or the openings 330 extend along a length of the chamber, thereby allowing bypass along a range of positions.

If the spring 400 suffers a spring failure 410, the poppet 300 translates to a third position, as shown in FIG. 2C. In the third position, the distal end 304 of the poppet 300 is in contact with the stop 270 and the sidewall 310 of the poppet covers the outlets 250. Accordingly, in the third position, the valve 100 functions similarly to first position. That is, the fluid F2 may enter the chamber 230 but the poppet 300 prevents the fluid F2 from exiting the outlets 250. Instead, the fluid F2 continues to move through the fluid movement system.

It the event of spring failure 410, the bypass valve 100, as configured in FIGS. 2A-2C, would no longer provide the over-pressurization protection for which it is intended. Accordingly, there are several additional features that may be included to provide additional safeguards. For example, the bypass valve 100 may include an additional spring (not shown) located between distal end 304 of the poppet 300 and the stop 270. In addition to the additional spring, the poppet 300 may include additional openings through the sidewall (not shown) which are proximal of the openings 330. In such an embodiment, the additional spring and additional openings would operate much like the spring 400 and the openings 330. In this embodiment, the poppet 300 would have five positions: first (closed, fully proximal), second (open, pressure compressing spring 400), third (closed, spring failure permits distal translation to contact the addition spring), fourth (open, pressure compressing the additional spring and aligning the additional openings with the outlets 250), and fifth (closed, additional spring failure). Alternatively, instead of the additional spring, the stops 270 could be designed to yield at a specific pressure, thereby permitting further translation of the poppet 300 to facilitate aligning the additional openings in the sidewall 310 with the outlets 250. An additional solution to the loss of over-pressurization protection following spring failure 410 may include placing two bypass valves 100 in series in the fluid movement system.

The bypass valve 100 may also include a spring failure indicator (not shown). The spring failure indicator may be physical indicator visible from the exterior of the bypass valve 100 while the valve is installed in a fluid movement system. For example, the indicator may be a brightly color peg configured to protrude from the cap 220 when the distal end 304 of the poppet 300 contacts the stop 270, signaling to an operator or mechanic that the bypass valve 100 needs replaced. Alternatively, the indicator may be a window near the stop 270 that enables the operator to see whether the poppet 300 is in the third position, signaling spring failure, and the need to replace the bypass valve 100. The indicator may also be electronic. For example the indicator may be a pressure sensor on stop 270 which is connected to a computer that notifies the operator of the spring failure.

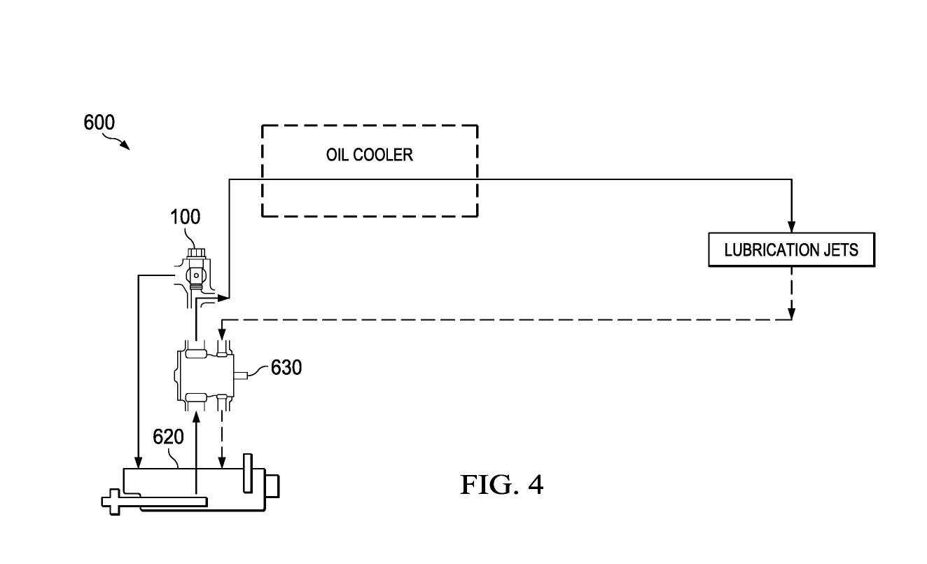

FIG. 3 shows a rotor gearbox 500 for use with a main rotor of a rotorcraft. The gearbox 500 is equipped with an oil distribution system 600. A schematic of the distribution system 600 is shown in FIG. 4. The oil distribution system 600 includes a channel 610 connecting the various components of the system 600. The distribution system 600 includes a sump 620 connected via the channel 610 to a pump 630. Upstream from the pump 630, the channel 610 includes an opening configured to receive the bypass valve 100 therein. The oil distribution system 600 may also include an oil cooler, oil filter, and lubrication jets. The oil distribution system 600 may also include additional bypass valves, spring biased pressure regulators, and pressure transducers that may include a similar structure to prevent spring failure from completely shutting down the flow of oil in the system 600.

It should be noted that, while the bypass valve is described in connection with an oil distribution system on a rotor gearbox for a rotorcraft, the bypass valve could be utilized to protect any pressurized fluid distribution system. For example, oil distribution on an internal combustion engine or a turbine engine, or in a hydraulic drive system.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, R₁₁, is disclosed, any number falling within the range is specifically disclosed. In particular, the following numbers within the range are specifically disclosed: R=R₁+k *(R₁₁−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A bypass valve, comprising:
a housing defining a chamber, the housing including an inlet and an outlet in a sidewall of the housing, both in communication with the chamber, the chamber including a distal end opposite the inlet, a shoulder proximate the distal end, a length extending from the distal end to the inlet, and a width transverse to the length;
a poppet configured to fit within and translate along at least a portion of the length of the chamber, the poppet including a first end configured to be oriented toward the inlet, a second end opposite the first end, and a partition configured to extend across the width of the chamber, the poppet further including a sidewall extending from the partition to the first end, the sidewall including an opening therethrough; and
a spring configured to fit within the chamber and to bias the poppet towards a first position wherein the poppet prevents communication between the inlet and the outlet, the spring being further configured to compress, thereby allowing the poppet to translate to a second position wherein the opening in the sidewall of the poppet aligns with the outlet in the sidewall of the housing, thereby placing the inlet and the outlet in communication;
wherein failure of the spring would permit the poppet to translate to a third position wherein the second end of the poppet contacts the shoulder and the sidewall of the poppet prevents communication between the inlet and the outlet.

2. The bypass valve of claim 1, wherein the housing comprises a body and a cap, the cap being configured to threadably engage the body.

3. The bypass valve of claim 2, wherein the chamber includes a recess distal of the shoulder, the recess being configured to receive a distal end of the spring, and wherein the poppet further includes a cavity distal of the partition configured to receive a proximal end of the spring.

4. The bypass valve of claim 3, wherein the chamber is at least in part cylindrical and an outer surface of the poppet is at least in part cylindrical.

5. The bypass valve of claim 4, wherein an exterior of the cap is configured for engagement with a tool.

6. The bypass valve of claim 5, further comprising a spring failure indicator. The bypass valve of claim 6, wherein the housing includes a second outlet and the poppet includes a second opening in the sidewall.

8. A fluid movement system, comprising:
a channel configured to permit the movement of a fluid therethrough;
a pump connected to the channel, wherein the pump is configured to move the fluid through the channel; and
a bypass valve connected to the channel upstream of from the pump, the bypass valve comprising:
a housing defining a chamber, the housing including an inlet and an outlet in a sidewall of the housing, both in communication with the chamber, the chamber including a distal end opposite the inlet, a stop proximate the distal end, a length extending from the distal end to the inlet, and a width transverse to the length;
a poppet configured to fit within and translate along at least a portion of the length of the chamber, the poppet including a first end configured to be oriented toward the inlet, a second end opposite the first end, and a partition configured to extend across the width of the chamber, the poppet further including a sidewall extending from the partition to the first end, the sidewall including an opening therethrough; and
a spring configured to fit within the chamber and to bias the poppet towards a first position wherein the poppet prevents communication between the inlet and the outlet, the spring being further configured to compress, thereby allowing the poppet to translate to a second position wherein the opening in the sidewall of the poppet aligns with the outlet in the sidewall of the housing, thereby placing the inlet and the outlet in communication;
wherein failure of the spring would permit the poppet to translate to a third position wherein the second end of the poppet contacts the stop and the sidewall of the poppet prevents communication between the inlet and the outlet.

9. The fluid movement system of claim 8, wherein the housing comprises a body and a cap, the cap being configured to threadably engage the body.

10. The fluid movement system of claim 9, wherein the chamber includes a recess distal of the stop, the recess being configured to receive a distal end of the spring, and wherein the poppet further includes a cavity distal of the partition configured to receive a proximal end of the spring.

11. The fluid movement system of claim 10, wherein the chamber is at least in part cylindrical and an outer surface of the poppet is at least in part cylindrical.

12. The fluid movement system of claim 11, wherein an exterior of the cap is configured for engagement with a tool.

13. The fluid movement system of claim 12, further comprising a spring failure indicator.

14. The fluid movement system of claim 13, wherein the housing includes a second outlet and the poppet includes a second opening in the sidewall.

15. A rotorcraft, comprising:
a rotor with blades attached thereto;
a fuselage; and
a gearbox including an oil distribution system, the oil distribution system comprising:
a channel configured to permit the movement of oil therethrough;
a pump connected to the channel, wherein the pump is configured to move the oil through the channel; and
a bypass valve connected to the channel upstream of the pump, the bypass valve comprising:
a housing defining a chamber, the housing including an inlet and an outlet in a sidewall of the housing, both in communication with the chamber, the chamber including a distal end opposite the inlet, a shoulder proximate the distal end, a length extending from the distal end to the inlet, and a width transverse to the length;
a poppet configured to fit within and translate along at least a portion of the length of the chamber, the poppet including a first end configured to be oriented toward the inlet, a second end opposite the first end, and a partition configured to extend across the width of the chamber, the poppet further including a sidewall extending from the partition to the first end, the sidewall including an opening therethrough; and
a spring configured to fit within the chamber and to bias the poppet towards a first position wherein the poppet prevents communication between the inlet and the outlet, the spring being further configured to compress, thereby allowing the poppet to translate to a second position wherein the opening in the sidewall of the poppet aligns with the outlet in the sidewall of the housing thereby placing the inlet and the outlet in communication;
wherein failure of the spring would permit the poppet to translate to a third position wherein the second end of the poppet contacts the shoulder and the sidewall of the poppet prevents communication between the inlet and the outlet.

16. The rotorcraft of claim 15, wherein the housing comprises a body and a cap, the cap being configured to threadably engage the body.

17. The rotorcraft of claim 16, wherein the chamber includes a recess distal of the stop, the recess being configured to receive a distal end of the spring, and wherein the poppet further includes a cavity distal of the partition configured to receive a proximal end of the spring.

18. The rotorcraft of claim 17, wherein the chamber is at least in part cylindrical and an outer surface of the poppet is at least in part cylindrical.

19. The rotorcraft of claim 18, wherein an exterior of the cap is configured for engagement with a tool.

20. The rotorcraft of claim 19, wherein the housing includes a second outlet and the poppet includes a second opening in the sidewall.
